(19) United States
(12) Patent Application Publication
(10) Pub. No.: US 2022/0407716 A1
(43) Pub. Date: Dec. 22, 2022

(54) AUTHENTICATED POINT CLOUD DATA

(71) Applicant: Motional AD LLC, Boston, MA (US)

(72) Inventors: Michael Maass, Pittsburgh, PA (US); Karl Robinson, Norwell, MA (US); Andrew Spangler, Medford, MA (US)

(21) Appl. No.: 17/353,786

(22) Filed: Jun. 21, 2021

(51) Int. Cl. H04L 9/32; H04L 29/12; H04L 29/08; H04L 12/801; H04L 9/08

(52) U.S. Cl. CPC H04L 9/3242; H04L 61/2007; H04L 67/10; H04L 47/34; H04L 9/0869; G01S 13/931

(57) ABSTRACT

Enclosed are embodiments for authenticating point cloud data. In an embodiment, a method of authenticating point cloud data comprises: generating, with at least one processor, a point cloud packet, the point cloud packet comprising a header portion and a data section, the data section comprising a plurality of blocks, each block comprising point cloud data; generating, with the at least one processor, a message sequence number (MSN); storing, with the at least one processor, the MSN in the data section; generating, with the at least one processor, a message authentication code (MAC) on the data section; storing the MAC in the point cloud packet; and transmitting, with the at least one processor, the point cloud packet to a receiving device.

### FIELD OF THE INVENTION

The description that follows relates generally to data authentication systems and methods.

### BACKGROUND

Autonomous vehicles often use a perception stack that operates on sensor data, such as point cloud data (e.g., LiDAR point cloud data), to perform accurate object detection, which is critical to the safe operation of the autonomous vehicles. Testing, however, has discovered that real-time patching of point cloud data is feasible, making point cloud data vulnerable to tampering. Also, point cloud data delivery is vulnerable to replay or sample and hold attacks, and such attacks do not require a physical man-in-the-middle (MITM) device, as rogue software entities are sufficient to carry out the attack.

### SUMMARY

Techniques are provided for authenticating point cloud data.

In an embodiment, a method of authenticating point cloud data comprises: generating, with at least one processor, a point cloud packet, the point cloud packet comprising a header portion and a data section, the data section comprising a plurality of blocks, each block comprising point cloud data; generating, with the at least one processor, a message sequence number (MSN); storing, with the at least one processor, the MSN in the data section; generating, with the at least one processor, a message authentication code (MAC) on the data section; storing the MAC in the point cloud packet; and transmitting, with the at least one processor, the point cloud packet to a receiving device.

In an embodiment, the header comprises at least a version number, a time-to-live value, a source address and a destination address.

In an embodiment, the header is an Internet Protocol (IP) header.

In an embodiment, the point cloud packet comprises at least a source port, a destination port, a length and a checksum.

In an embodiment, each block of point cloud data comprises a single azimuth angle and a plurality of vertical angles corresponding to the azimuth angle for the points in the point cloud, wherein the azimuth angle and the plurality of vertical angles are measured in a point cloud reference coordinate system.

In an embodiment, each block of the plurality of blocks comprises a fixed header.

In an embodiment, the MAC is 4 to 8 bytes in length.

In an embodiment, the point cloud data is generated by a depth sensor of an autonomous vehicle, and wherein transmitting the point cloud packet from the depth sensor to the receiving device, further comprises: generating at least one session key; generating a message including the point cloud packet; encrypting the message using the at least one session key; establishing a communications session between the depth sensor and the receiving device; an transmitting, during the established communication session, the encrypted message from the depth sensor to the receiving device.

In an embodiment, generating the at least one session key further comprises: transmitting, by the receiving device, a first salt to the depth sensor; receiving, by the receiving device, a synchronization message from the depth sensor, the synchronization message comprising an amount of entropy; generating, by the receiving device, a second salt based on the first salt and the amount of entropy; and generating the at least one session key based on the second salt.

In an embodiment, the depth sensor is a light detection and ranging (LiDAR) sensor.

In an embodiment, the depth sensor is a time-of-flight (TOF) sensor.

In an embodiment, the depth sensor is a RADAR.

In an embodiment, the depth sensor is sound navigation and ranging (SONAR).

In an embodiment, the method comprises: receiving, with at least one processor or receiving device, an encrypted message including a point cloud packet, the point cloud packet comprising a header portion, a data section, a message authentication code (MAC) and a message sequence number (MSN), the data section including a plurality of blocks, each block comprising point cloud data; decrypting, with the at least one processor, the encrypted message; parsing, with the at least one processor, the point cloud data, the MAC and the MSN from the point cloud packet; authenticating the point cloud data based on the MAC and the MSN; and transmitting, with the at least one processor, the point cloud data to a storage device or another device.

In an embodiment, the method further comprises: sending, with the at least one processor, the point cloud data to a perception circuit of an autonomous vehicle, the perception circuit configured to predict at least one physical state (e.g., position, velocity, heading) of at least one object in an operating environment of the autonomous vehicle.

In an embodiment, the method further comprises: generating, with the at least one processor, a trajectory for the autonomous vehicle in the operating environment based at least in part on the predicted at least one physical state.

These and other aspects, features, and implementations can be expressed as methods, apparatus, systems, components, program products, means or steps for performing a function, and in other ways. These and other aspects, features, and implementations will become apparent from the following descriptions, including the claims.

### BRIEF DESCRIPTION OF THE DRAWINGS

FIG. 1 shows an example of an autonomous vehicle (AV) having autonomous capability, in accordance with one or more embodiments.

FIG. 2 illustrates an example “cloud” computing environment, in accordance with one or more embodiments.

FIG. 3 illustrates a computer system, in accordance with one or more embodiments.

FIG. 4 shows an example architecture for an AV, in accordance with one or more embodiments.

FIG. 5 is a block diagram of packet-based communication system for an autonomous vehicle, in accordance with one or more embodiments.

FIG. 6A illustrates a point cloud packet format, in accordance with one or more embodiments.

FIG. 6B illustrates the inclusion of a MAC, and MSN and point cloud data in the point cloud packet of FIG. 6A, in accordance with one or more embodiments.

FIG. 6C illustrates a point cloud data representation, in accordance with one or more embodiments.

FIG. 6D illustrates a coordinate reference system for representing point cloud data, in accordance with one or more embodiments.

FIG. 6E illustrates the inclusion of point cloud data in a data portion of the point cloud data packet, in accordance with one or more embodiments.

FIG. 7 is a flow diagram illustrating an example process for session key generation for authenticating point cloud data, in accordance with one or more embodiments.

FIG. 8 is a flow diagram of a process of authenticating point cloud data performed by a sensor processor, in accordance with one or more embodiments.

FIG. 9 is a flow diagram of a process of authenticating point cloud data performed by a host processor, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. System Overview
3. Autonomous Vehicle Architecture
4. Authenticating Point Cloud Data

### General Overview

Techniques are provided for authenticating point cloud data. A depth sensor (e.g., a LiDAR sensor) is configured to generate a point cloud and transmit a point cloud packet containing the point cloud data to a host system, such as a perception system and/or a localization system of an autonomous vehicle. The point cloud packet comprises a header portion and a data portion. In an embodiment, the point cloud packets are transmitted by the depth sensor to the host system during a secure communication session between the sensor and the host system. The point cloud packet includes a message sequence number (MSN) for monitoring the order of packets arriving at the host system and a message authentication code (MAC) (e.g., generated on the point cloud data and the MSN) that is used by the host system to authenticate the point cloud packet prior to using the point cloud data.

Some of the advantages of these techniques include increased security of the point cloud data. Specifically, a sensor (e.g., a LiDAR sensor) in a point cloud packet system protects a point cloud data packet containing a point cloud data payload (e.g., LiDAR point cloud data) by adding a message sequence number (MSN) to the packet, and by calculating a message authentication code (MAC) on the point cloud data and MSN and adding it to the packet. A host system receives the point cloud data packet and verifies the MSN is increasing and calculating and checking the MAC to determine if the payload is authentic (e.g., has not been corrupted or tampered with or otherwise modified from the time it was generated).

The disclosed embodiments authenticate the point cloud data and reduce processing cycles and bandwidth load compared with other authentication methods, such as transport layer security (TLS) methods. The disclosed embodiments are also easy to implement without specialized hardware and more easy to test thoroughly (e.g., to ensure safety) than TLS. Because a standard Internet Protocol (IP) header (e.g., IPv4, IPv6) and a user datagram protocol (UDP) datagram are used for the point cloud packet format, the point cloud packet format is compatible with standard transmission control protocol (TCP)/IP stacks.

### System Overview

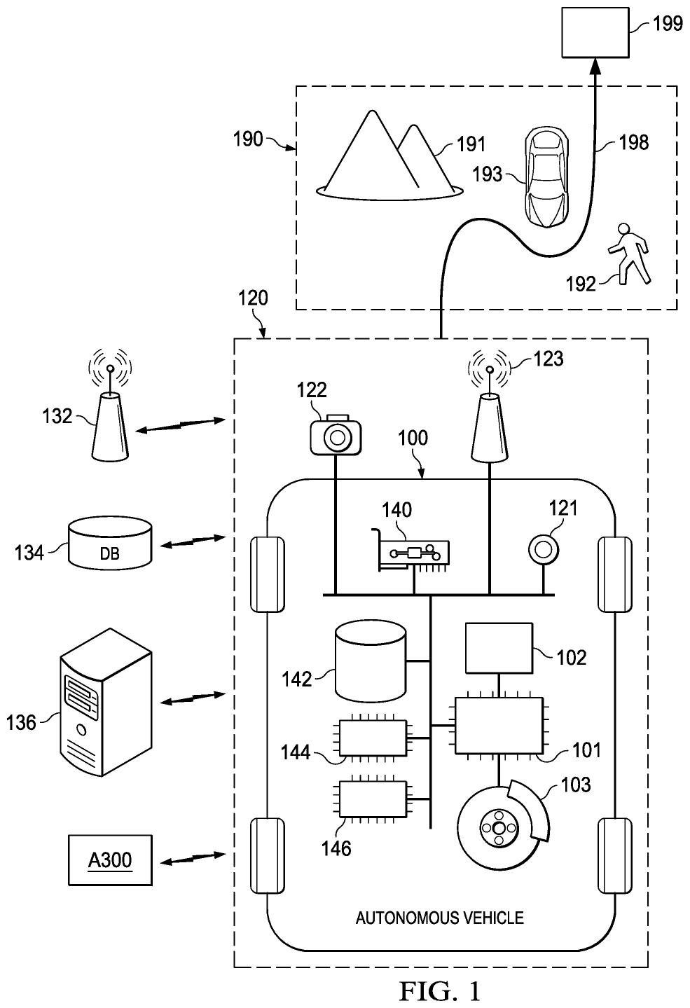

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, motorcycles, bicycles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

As used herein, “ego vehicle” or “ego” refers to a virtual vehicle or AV with virtual sensors for sensing a virtual environment that is utilized by, for example, a planner to plan the route of the virtual AV in the virtual environment.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

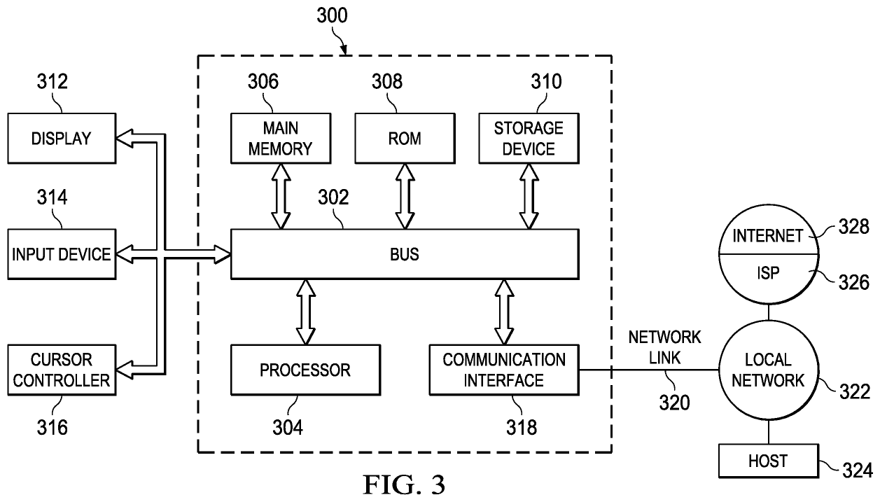

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are a Global Navigation Satellite System (GNSS) receiver, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

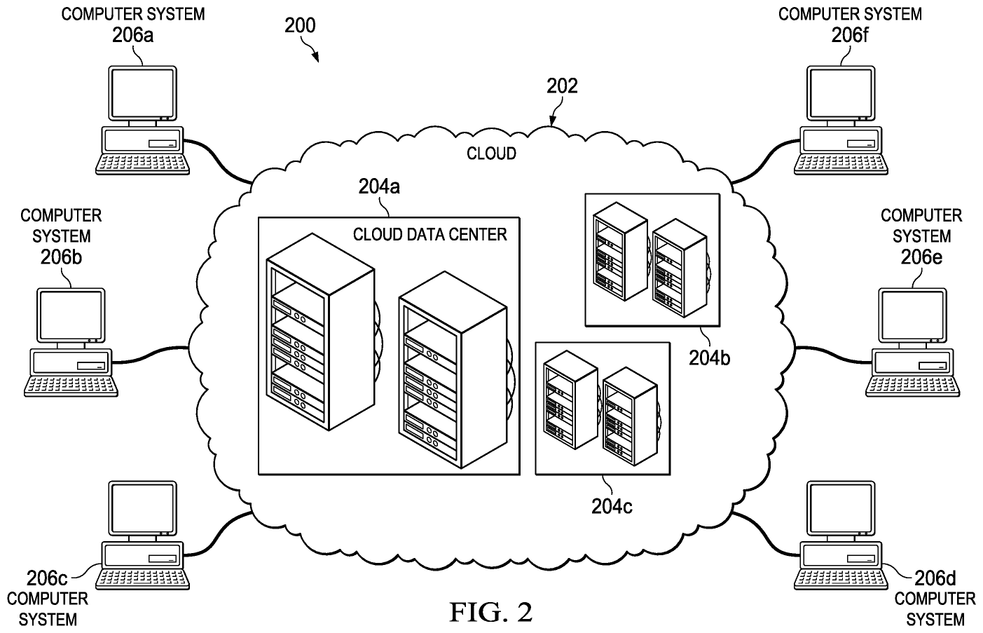

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Computer System

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

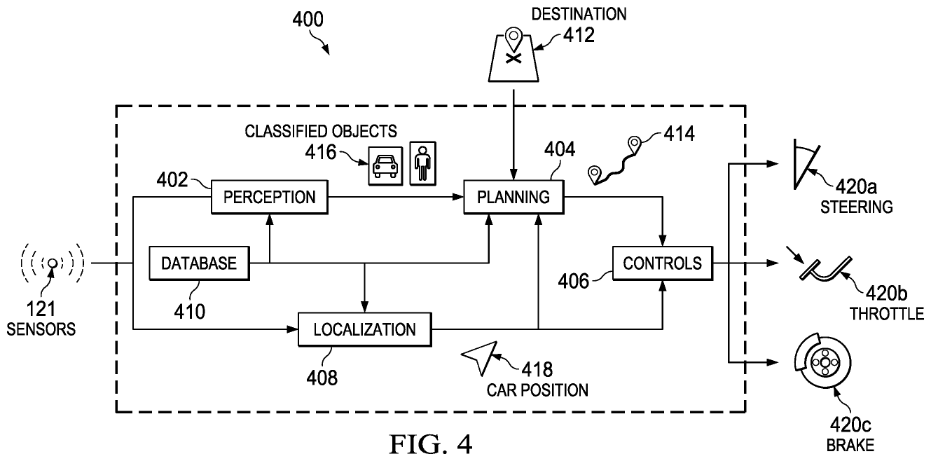

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits (ASICs)), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

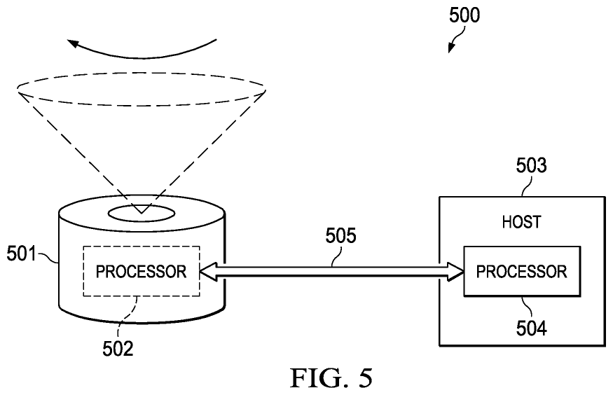

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS receiver and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. Typically, the high-precision maps are hand-annotated, which is a labor intensive process. To reduce the amount of labor the maps can be annotated using an ML-based framework, as described in reference to FIG. 5.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Authenticating Point Cloud Data

FIG. 5 is a block diagram of packet-based communication system 500 for an autonomous vehicle, in accordance with one or more embodiments. Sensor 501 includes processor 502 which is used to establish a communication session with processor 504 of host system 503 over one or more communication channels 505. Host system 503 can be any system that uses or relays point cloud data. In the example shown, host system 503 includes but is not limited to perception module 402, localization module 408, or any other module in architecture 400 configured to receive authenticated point cloud data. In an embodiment, sensor 501 can be any sensor that captures three-dimensional data, such as LiDAR (e.g., LiDAR 123), RADAR, ultrasonic sensors, time-of-flight (TOF) depth sensors and any other sensor that provides distance or depth measurements. In that example shown, depth sensor 501 is a LiDAR sensor mounted on the roof of an AV (e.g., AV 100) and rotates to cover a 360 degree field of view of the operating environment of the vehicle.

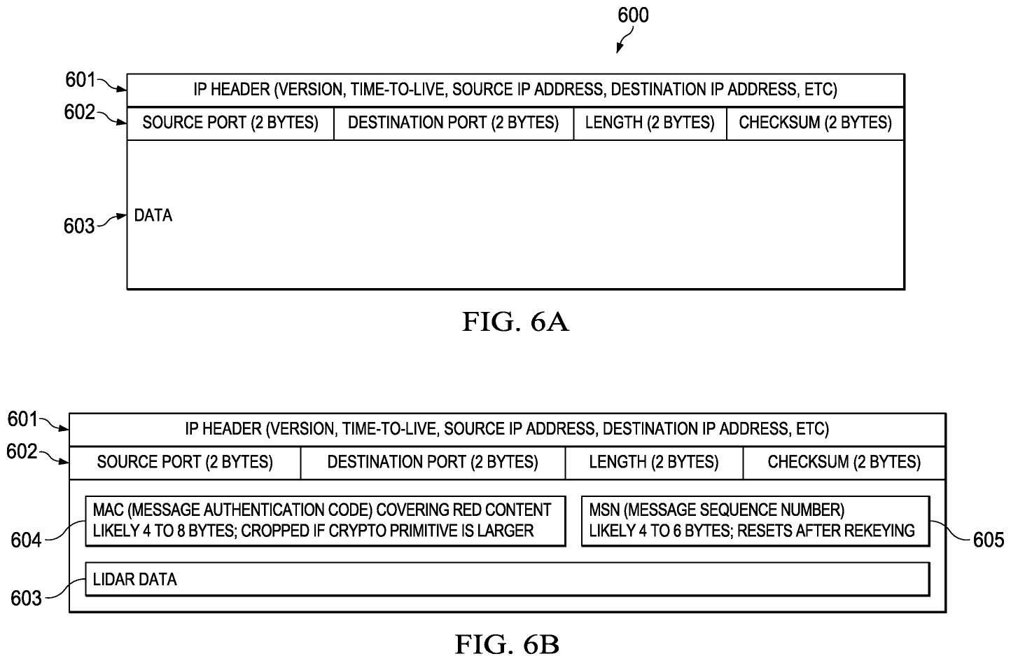

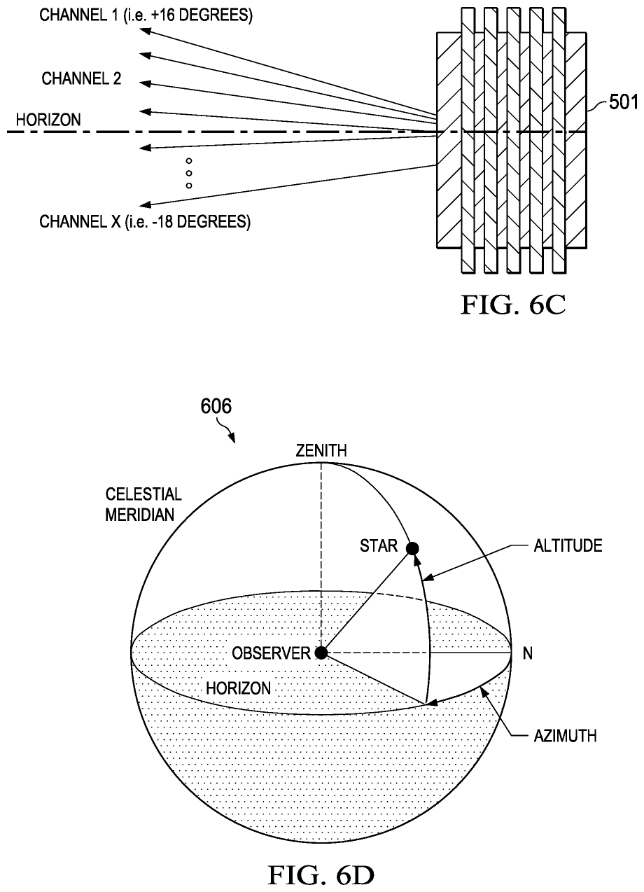

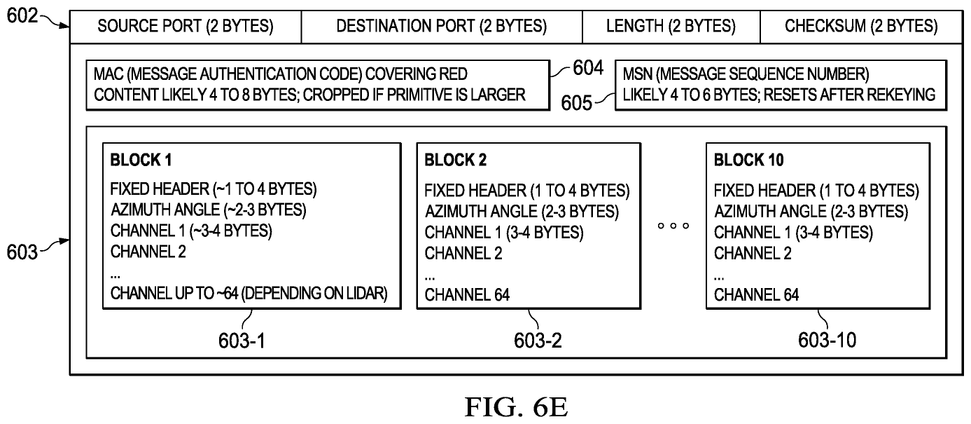

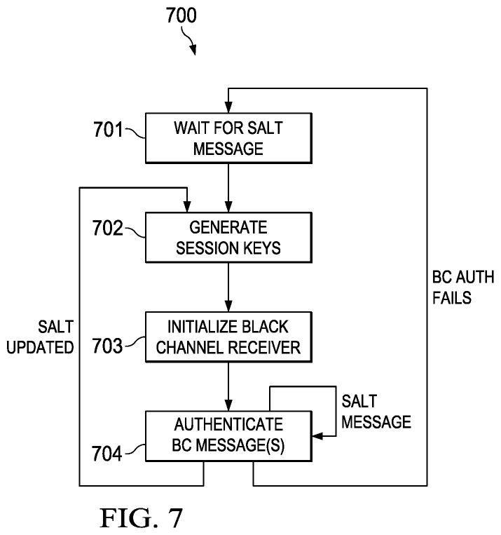

From a security perspective, the point cloud data, when transported on one or more communication channels 505, is vulnerable to tampering and replay and/or sample and hold attacks that could compromise the point cloud data, creating a potentially dangerous condition in the AV. To address this security issue, a point cloud packet format was designed with various security features, as described below in reference to FIGS. 6A, 6B, 6C, 6D, 6E and 7.

FIG. 6A illustrates a point cloud packet format 600, in accordance with one or more embodiments. Point cloud data packet format 600 includes IP header 601, UDP header 602 and data section 603. In an embodiment, IP header 601 is a standard Internet Protocol (IP) header (e.g., IPv4 or IPv6 header) that includes a version number, time-to-live parameter, source address (e.g., source IP address), destination address (e.g., destination IP address), etc. UDP header 602 combined with data section 603 comprises a UDP datagram. UDP header 602 includes source and destination port numbers, a packet length and a checksum. The source port number is the port of the sender, the destination port number is the port the datagram is addressed to, length is the length in bytes of the UDP header 602 and the checksum is used in error checking (required in IPv6 and optional in IPv4). The UDP packet (UDP header 602 plus data section 603) is encapsulated in IP packet 600 with IP header 601, and transported to the IP destination identified in IP header 601.

FIG. 6B illustrates the inclusion of MAC 604 and MSN 605 in the point cloud packet 600 of FIG. 6A, in accordance with one or more embodiments. MSN 605 is a count of messages sent by processor 502. In an embodiment, MAC 604 (e.g., 4 to 8 bytes) and MSN 605 (e.g., 4 to 6 bytes) are used to prevent message replay or modification attacks. A replay attack is a form of network attack in which an MITM device or rogue software intercepts the point cloud data and re-transmits the point cloud data as part of, for example, a spoofing attack by IP packet substitution.

In an embodiment, MAC 604 is computed using a MAC secret, MSN 605 and the point cloud data. In other embodiments, MAC 604 is computed also using the data length and fixed character strings (e.g., two fixed hexadecimal character strings) as described in reference to FIG. 6E. When processor 504 computes MAC 604 for a given point cloud data packet 600, if MSN 605 does not correspond to the current point cloud data packet, the authentication will fail, and the packet will be discarded.

FIG. 6C illustrates a point cloud representation, in accordance with one or more embodiments. Sensor 501 (e.g., a LiDAR sensor) sweeps a 360 degree field-of-view (FOV) in multiple rings (referred to as “channels”) defined by vertical or elevation angle above a horizon. As shown in the example model of FIG. 6C, channel 1 is +16 degrees above the horizon, channel 2 is “x” degrees lower (e.g., +3.0 degrees) and so forth until channel “X” is −18 degrees below the horizon. Thus, for a particular azimuth angle, there are “x” channels of point cloud data. FIG. 6D illustrates an example coordinate reference system 606 for representing the point cloud data using azimuth and vertical (elevation) angles.

FIG. 6E illustrates the inclusion of point cloud data in a data section of the point cloud data packet, in accordance with one or more embodiments. In an embodiment, the point cloud data is organized in data section 603 of point cloud data packet 600 in blocks, where each block includes a fixed header (e.g., 1-4 bytes), an azimuth angle (e.g., 2-3 bytes) and x channels (e.g., 64 channels) that are associated with the azimuth angles depending on the sensor. With this format, each block contains point cloud data for particular “slice” of the 3D point cloud. The fixed header is used to assist in parsing data section 603 of point cloud packet 600. For purposes of MAC generation, the internal structure of data section 603 is treated as a byte array.

In an embodiment, MAC 604 is includes data section 603 and MSN 605 to prevent replay attacks and tampering attacks. In another embodiment, MAC 604 may also include some or of the fields in header 601 and 602. However, MAC 604 does not have to include the fields of header 601 or header 602 (e.g., source IP address, destination IP address). If the source IP address is used as the lookup for a particular sensor authentication cryptographic key, then spoofing the source IP address (as an attacker) would fail authentication under that key. If the destination IP address is wrong the point cloud packet 600 may not be delivered, which is similar to a denial-of-service (DoS) attack that is possible regardless of whether the destination IP is included in the packet.

FIG. 7 is a flow diagram illustrating an example process 700 for session key generation, in accordance with at least one embodiment. In an embodiment, process 700 is performed by sensor processor 502 and host processor 504 shown in FIG. 5. Other entities, for example, a server (e.g., server 136), a computer system (e.g., computer system 300), a mobile device, or an AV system (e.g., AV system 120) perform some or all of the elements of the process in other embodiments. Additionally, other embodiments of the technique include more or fewer elements, different elements, elements performed in a different order than depicted, etc.

Each communication session between sensor processor 502 and host processor 504 is configured to prevent replay attacks by a malicious entity by enabling sensor processor 502 to generate and contribute an entropy to a salt used to generate session keys. A replay attack refers to a network attack in which a valid data is maliciously or fraudulently repeated or delayed by a malicious entity. For example, a malicious entity that intercepts a message containing a point cloud packet can launch a replay attack using the message as part of a spoofing attack by IP packet substitution.

At startup, when sensor processor 502 joins a session with host processor 504, host processor 505 waits (701) to receive a salt message generated by sensor processor 502. In an embodiment, host processor 504 sends a notification to sensor processor 502 requesting a data transfer. In response to the request, host processor 504 receives a salt message from sensor processor 502 including a salt. In an embodiment, the salt includes random bits that are added to an instance of a password (e.g., session keys) before the password is hashed. In an embodiment, host processor 504 selects a salt from an entropy pool. Entropy refers to an average level of information inherent in a random variable's possible values. For example, entropy represents a mathematical limit on lossless compression of data onto a noiseless channel. The salt is used to create unique passwords even when host processor 504 and sensor processor 502 use the same session keys. The embodiments disclosed herein thus prevent rainbow table attacks by forcing a malicious entity to re-compute the session keys using the salts. A rainbow table attack is a type of hacking attack where a perpetrator tries to use a rainbow hash table to crack passwords stored in a database system.

The salt is used by host processor 504 to calculate session keys (702) for the communication session with sensor processor 502 and to authenticate and decode (or decrypt) protected messages received from sensor processor 502. In an embodiment, protected messages are transmitted over a network connection, for example, a local network 322, such as a controller area network (CAN) bus or Ethernet. In an embodiment, sensor processor 502 broadcasts the salt to host processor 504 for generation of session keys for a communication session.

In an embodiment, session keys are generated by host processor 504 using a hashed key derivation function (HKDF), an input key material (IKM) and the salt. For example, the session keys are determined using an HKDF based on a hash-based message authentication code (HMAC). A session key is an encryption and decryption key that is randomly generated to ensure the security of a communications session between host processor 504 and sensor processor 502. Session keys are sometimes called symmetric keys, because the same key is used for both encryption and decryption of protected messages passed from sensor processor 502 to host processor 505. An HKDF is a key derivation function (KDF) based on an HMAC. An HKDF is used as a building block in various protocols and applications, and to prevent the proliferation of multiple KDF mechanisms. An HMAC is a type of MAC involving a cryptographic hash function and a secret cryptographic key (e.g., a salt). In an embodiment, an IKM, which is a cryptographically weak pseudorandom string, is used for extracting a fixed-length pseudorandom key. The fixed-length pseudorandom key is expanded into several additional pseudorandom keys (the output of the HKDF), represented as follows in equation (1):

session keys=[HKDF(IKM,salt)] [1]

Host processor 504 initializes (703) its receiver using the session keys, such that it is ready to receive protected messages from sensor processor 502 for the purpose of receiving point cloud data. The message receiver is a part of host processor 504 and is implemented using the components of the example computer system 300 illustrated and described in more detail with reference to FIG. 3. Host processor 504 commences receiving protected messages from sensor processor 502. Periodically a salt message, containing the salt generated or selected at startup by sensor processor 502, is received.

In an embodiment, the first one or more protected messages received by host processor 504 from sensor processor 502 are used to authenticate subsequent protected message(s) and their session keys (704). After the session keys and the first one or more protected messages are authenticated, host processor 504 receives subsequent protected messages carrying point cloud data in the example format described in reference to FIGS. 6A-6E. The salt message is updated and used to generate session keys (702).

### Example Processes

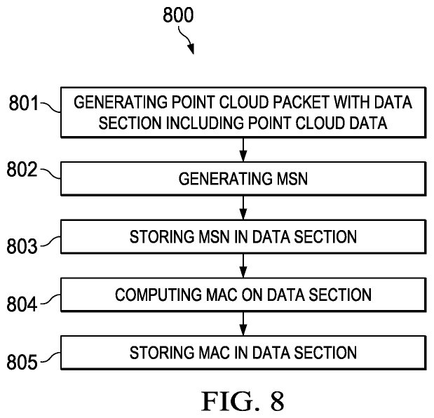

FIG. 8 is a flow diagram of a process 800 of authenticating point cloud data performed by a sensor processor, in accordance with one or more embodiments. Process 800 can be implemented using, for example, computer system 300 as described in reference to FIG. 3.

Process 800 comprises generating a point cloud packet (801). In an embodiment, the point cloud packet comprising a header portion and a data portion, and the data portion comprises a plurality of blocks, where each block comprises point cloud data. The point cloud packet can be generated by sensor processor (e.g., sensor processor 502) or one or more other processors.

Process 800 continues by generating a MSN (802), storing the MSN in the data portion (803), computing a MAC on the data portion (804) and storing the MAC in the data portion (805), as described in reference to FIGS. 6A-6E.

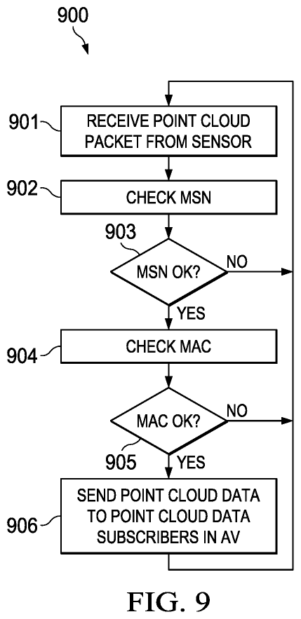

FIG. 9 is a flow diagram of a process 900 of authenticating point cloud data performed by a host processor, in accordance with one or more embodiments. Process 900 can be implemented using, for example, computer system 300 as described in reference to FIG. 3.

Process 900 comprises receiving a message including a point cloud packet (901). In an embodiment, the point cloud packet comprises a header portion, a data section, a MAC and a MSN, and the data section includes a plurality of blocks, where each block comprises point cloud data.

Process 900 continues by parsing the point cloud data, the MAC and the MSN from the point cloud packet and checking the MSN (902). If the MSN is verified (903) process 900 continues by checking the MAC (904). If the MAC is verified (905) the point cloud data is deemed authenticated and process 900 continues by sending the authenticated point cloud data to point cloud subscribers in the AV (906).

In some embodiments, the MAC is calculated by the sensor processor using a secret key generation algorithm and a signing algorithm, and verified by the host processor using a verifying algorithm. The key generation algorithm chooses a secret key at random. The signing algorithm outputs a MAC (also called a “tag”) when given the secret key and the data section containing the MSN and point cloud data. The verifying algorithm verifies the authenticity of the data section using the secret key and MAC, and returns a message of accepted if the message and MAC are authentic and unaltered.

For example, the sensor processor sends a message (i.e., the data section containing the MSN and point cloud data) through the MAC algorithm, which generates a key and attaches a MAC to the message. The host processor receives and parses the message from the point cloud packet, runs the MAC algorithm on the message with the same secret key, and outputs a second MAC. The second MAC is then compared with the first MAC attached to the message when it was transmitted by the sensor processor. If the first MAC and second MAC are the same, the host processor can safely assume that the data integrity of the message is intact. If the first MAC and second MAC do not match, the message was altered, tampered with or forged.

After the MSN is verified it is used to guarantee that the message was only sent once. Otherwise, the AV could be vulnerable to a replay attack, in which an attacker intercepts the message and retransmits it at a later time, replicating the original results and gaining access to the point cloud data.

The MAC algorithms can be constructed from cryptographic hash functions (e.g., HMAC) or from block cipher algorithms (e.g., one-key MAC, counter with cipher block chaining MAC (CBC-MAC), Galois/Counter Mode (GCM).

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A method comprising:
generating, with at least one processor, a point cloud packet, the point cloud packet comprising a header portion and a data section, the data section comprising a plurality of blocks, each block comprising point cloud data;
generating, with the at least one processor, a message sequence number (MSN);
storing, with the at least one processor, the MSN in the data section;
generating, with the at least one processor, a message authentication code (MAC) on the data section;
storing the MAC in the point cloud packet; and
transmitting, with the at least one processor, the point cloud packet to a receiving device.

2. The method of claim 1, wherein the header comprises at least a version number, a time-to-live value, a source address and a destination address.

3. The method of claim 2, wherein the header is an Internet Protocol (IP) header and the source address is a source IP address and the destination address is a destination IP address.

3. The method of claim 1, wherein the point cloud packet comprises at least a source port, a destination port, a length and a checksum.

4. The method of claim 1, wherein each block of point cloud data comprises a single azimuth angle and a plurality of vertical angles corresponding to the azimuth angle for the points in the point cloud, wherein the azimuth angle and the plurality of vertical angles are measured in a point cloud reference coordinate system.

5. The method of claim 1, wherein each block of the plurality of blocks comprises a fixed header.

6. The method of claim 1, wherein the MAC is 4 to 8 bytes in length.

7. The method of claim 1, wherein the point cloud data is generated by a depth sensor of an autonomous vehicle, and wherein transmitting the point cloud packet from the depth sensor to the receiving device, further comprises:
generating at least one session key;
generating a message including the point cloud packet;
encrypting the message using the at least one session key;
establishing a communications session between the depth sensor and the receiving device; and
transmitting, during the established communication session, the encrypted message from the depth sensor to the receiving device.

8. The method of claim 7, wherein generating the at least one session key further comprises:
transmitting, by the receiving device, a first salt to the depth sensor;
receiving, by the receiving device, a synchronization message from the depth sensor, the synchronization message comprising an amount of entropy;
generating, by the receiving device, a second salt based on the first salt and the amount of entropy; and
generating the at least one session key based on the second salt.

9. The method of claim 7, wherein the depth sensor is a light detection and ranging (LiDAR) sensor.

10. The method of claim 7, wherein the depth sensor is a time-of-flight (TOF) sensor.

11. The method of claim 7, wherein the depth sensor is a RADAR.

12. The method of claim 8, wherein the depth sensor is a SONAR.

13. A method comprising:
receiving, with at least one processor or receiving device, an encrypted message including a point cloud packet, the point cloud packet comprising a header portion, a data section, a message authentication code (MAC) and a message sequence number (MSN), the data section including a plurality of blocks, each block comprising point cloud data;
decrypting, with the at least one processor, the encrypted message;
parsing, with the at least one processor, the point cloud data, the MAC and the MSN from the point cloud packet;
authenticating the point cloud data based on the MAC and the MSN; and
transmitting, with the at least one processor, the point cloud data to a storage device or another device.

14. The method of claim 13, wherein the header includes at least a version number, a time-to-live value, a source address and a destination address.

15. The method of claim 14, wherein the header is an Internet Protocol (IP) header, the source address is a source IP address and the destination address is a destination IP address.

16. The method of claim 13, wherein the point cloud packet comprises at least a source port, a destination port, a length and a checksum.

17. The method of claim 13, wherein each block of point cloud data comprises a single azimuth angle and a plurality of elevation angles corresponding to the azimuth angle for the points in the point cloud, and wherein the azimuth angle and the plurality of elevation angles are measured in a point cloud reference coordinate system.

18. The method of claim 13, wherein each block of the plurality of blocks comprises a fixed header.

19. The method of claim 13, wherein the MAC is 4 to 8 bytes in length.

20. The method of claim 13, wherein the point cloud data is generated by a depth sensor of an autonomous vehicle, and wherein the message is transmitted to the receiving device, by:
generating at least one session key;
encrypting the message using the at least one session key;
establishing a communications session between the depth sensor and the receiving device; and
transmitting, during the established communication session, the encrypted message from the depth sensor to the receiving device.

21. The method of claim 20, wherein generating the at least one session key further comprises:
transmitting, by the receiving device, a first salt to the depth sensor;
receiving, by the receiving device, a synchronization message from the depth sensor, the synchronization message comprising an amount of entropy;
generating, by the receiving device, a second salt based on the first salt and the amount of entropy; and
generating the at least one session key based on the second salt.

22. The method of claim 13, further comprising:
sending, with the at least one processor, the point cloud data to a perception circuit of an autonomous vehicle, the perception circuit configured to predict at least one physical state of at least one object in an operating environment of the autonomous vehicle.

23. The method of claim 22, further comprising:
generating, with the at least one processor, a trajectory for the autonomous vehicle in the operating environment based at least in part on the predicted at least one physical state.
